(19) United States
(12) Patent Application Publication
(10) Pub. No.: US 2007/0277482 A1
(43) Pub. Date: Dec. 6, 2007

(54) RE-SEALING DEVICE

(75) Inventors: Robert Lloyd, Menlo Park, CA (US); Jerome A. Carlson, Woodside, CA (US)

Correspondence Address: URIARTE LAW, 257 RODONOVAN DRIVE, SANTA CLARA, CA, 95051, US

(73) Assignee: LLOYDCO, LLC, Menlo Park, CA (US)

(21) Appl. No.: 11/754,369

(22) Filed: May 29, 2007

Related U.S. Application Data
(60) Provisional application No. 60/870,848, filed on Dec. 20, 2006.
(60) Provisional application No. 60/810,318, filed on Jun. 1, 2006.

(51) Int. Cl. B67B 1/04; B65B 61/20

(52) U.S. Cl. 53/489; 53/284.6

(57) ABSTRACT

An apparatus is disclosed for inserting a previously compressed resilient stopper into a bottle and includes a plunger unit having a protrusion; a compressor having a first and second portion with the first portion having a first cavity that has a first aperture and a second aperture and with the second portion having a centering guide. The protrusion has a protrusion length sufficient to push the stopper along the first cavity so as to partially insert the stopper into a mouth of the bottle when the mouth is held against the centering guide. The first cavity has a dimension that compresses the stopper so that it fits into the mouth of the bottle when the stopper is pushed along the first cavity, while permitting the extraction of the compressor away from the stopper and the bottle without extracting the stopper from the mouth.

### CROSS-REFERENCE TO RELATED APPLICATIONS

This application claims the benefit of U.S. Provisional Application having Ser. No. 60/810,318, filed 1 Jun. 2006 and entitled, “Re-Sealing Device”, and U.S. Provisional Application having Ser. No. 60/870,848, filed 20 Dec. 2006 and entitled, “Re-Sealing Device.”

### BACKGROUND OF THE INVENTION

### Field of the Invention

The present invention generally relates to sealing a receptacle, such as a bottle, and more particularly, to sealing the receptacle by inserting a previously compressed or used stopper, such as a cork previously extracted from a wine bottle, into an orifice of the receptacle.

### BRIEF DESCRIPTION OF THE DRAWINGS

FIG. 1 is a sectional view of a stopper partially inserted into a receptacle using a guide and a compressor in accordance with one embodiment of the present invention;

FIG. 2 is a perspective view of a plunger unit for use with a compressor in accordance with another embodiment of the present invention;

FIGS. 3A and 3B are top and bottom views, respectively, of a compressor in accordance with another embodiment of the present invention;

FIG. 4 is a sectional view along line 4-4 of the plunger unit shown in FIG. 2;

FIG. 5 is a sectional view along line 5-5 of the compressor illustrated in FIG. 3A and FIG. 3B;

FIG. 6 is a perspective view of a plunger unit for use with a compressor in accordance with yet another embodiment of the present invention; and

FIG. 7 is a sectional view along line 4-4 of an alternative implementation of the plunger unit shown in FIG. 2 in accordance with another embodiment of the present invention.

### DETAILED DESCRIPTION OF THE INVENTION

While the invention has been described in conjunction with a specific best mode, it is to be understood that many alternatives, modifications and variations, including those that are outside of the specific dimensions or ranges of dimensions described herein, will be apparent to those skilled in the art in light of the following description. The use of these alternatives, modifications and variations in or with the various embodiments of the invention shown below would not require undue experimentation or further invention.

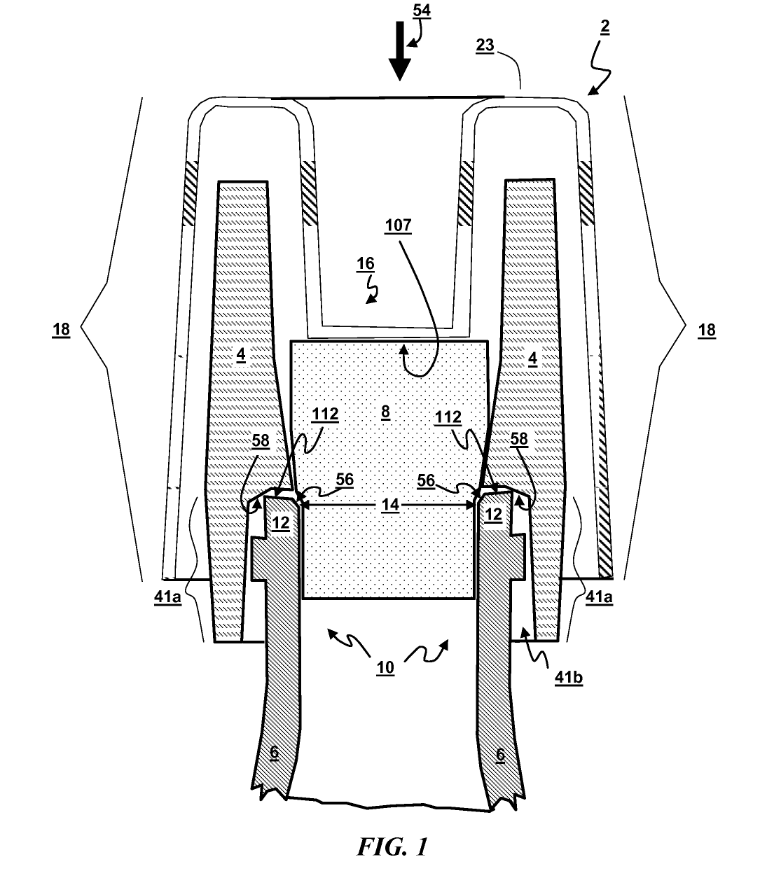

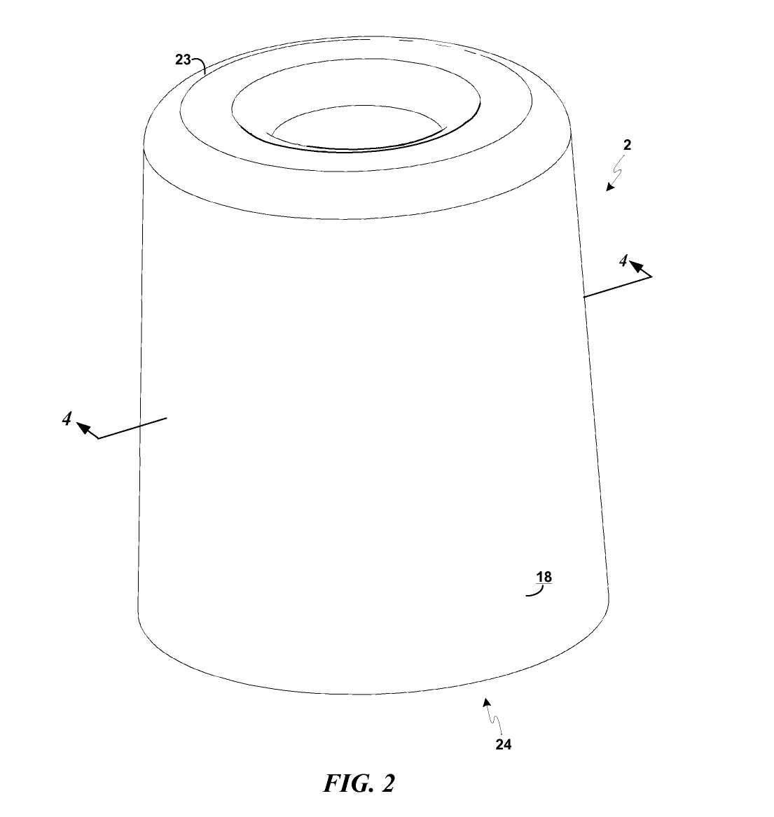

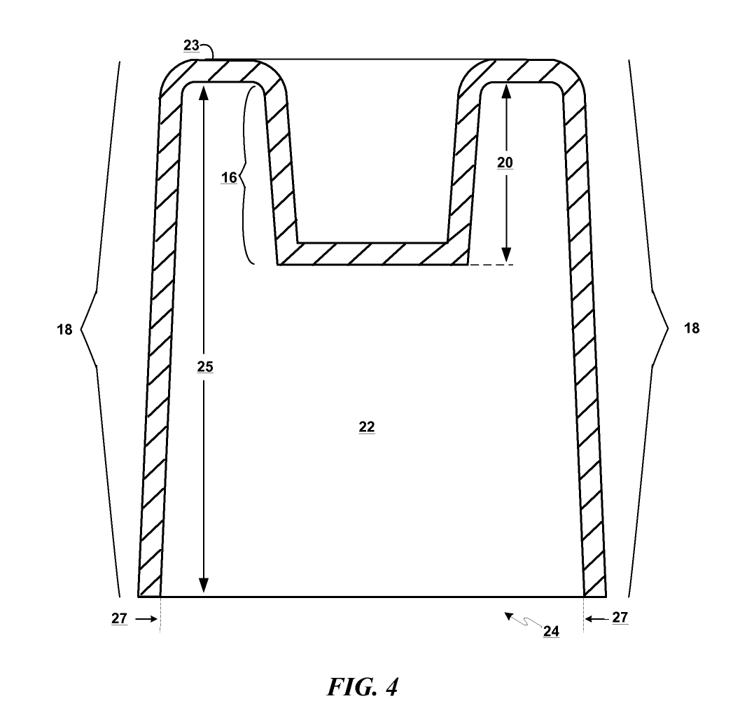

Referring now to the drawings wherein similar reference numerals denote similar parts, various embodiments of the present invention are disclosed in FIG. 1 through FIG. 5. These embodiments of the present invention are generally directed to using a plunger unit 2 with a compressor 4 to seal or plug a receptacle 6 using a stopper 8 that has been previously compressed, such as a stopper that was previously used to seal receptacle 6. For example, as shown in FIG. 1, a receptacle 6 is shown in the form of a standard wine bottle having a neck 10 and a mouth 12 having a mouth diameter 14. The embodiment of the present invention shown in FIG. 1 is not intended to be limited to a wine bottle but may be used with any vessel or container, such as a wine bottle or the like, having an opening that can receive a stopper, such as mouth 12 and stopper 8, respectively. It is contemplated that stopper 8 is made of resilient material, including rubber, cork, plastic and the like.

Referring to FIGS. 1 through 5, plunger unit 2 includes a protrusion 16 and an alignment shroud 18. Protrusion 16 is disposed within alignment shroud 18 and has a selected protrusion length 20. Alignment shroud 18 includes a shroud cavity 22 having a closed portion that forms a top surface 23 and an open portion that forms a shroud aperture 24 having a shroud aperture diameter 27, which may be from 36 to 40 mm. Compressor 4 includes a first portion 26 and a second portion 28. First portion 26 includes a first cavity 30 having a first aperture 32 and a second aperture 34.

It is currently contemplated that shroud cavity 22 include an inner shroud depth 25 that is a least greater than protrusion length 20, plus the length of a typical stopper that is contemplated for use with plunger unit 2 and compressor 4 and minus the length of the stopper that can be received by first cavity 30 before plunger unit 2 is coupled to compressor 4. For example, if plunger unit 2 and compressor 4 are intended to be used with a #9 cork stopper that was previously used to seal a wine bottle, inner shroud depth 25 may be configured to be from 40 to 70 mm. A cork stopper typically used to plug or seal wine bottles is commonly referred as a #9 cork stopper.

Second portion 28 of the compressor 4 includes at least a centering guide 36 although in the embodiment of the present invention shown in the applicable figures, second portion 28 may also include a first surface 38a having a first edge 38b defined by second aperture 34. First surface 38a is oriented and dimensioned so that if a receptacle having a large diameter mouth (not shown) is used, the resulting distance between the large diameter mouth and second aperture 34 is less than the distance that would have been created between them if first surface 38a had been omitted and centering guide 36 solely used. If implemented, first surface 38a may be oriented in an approximately perpendicular manner to a plane defined by the edges of the mouth when the mouth is placed against centering guide 36. In an alternative embodiment, first surface 38a may be configured to have a perpendicular orientation to centerline 44. Second portion 28 may also further include a flange 41a to stabilize receptacle 6 when neck 10 is inserted through flange aperture 41b and mouth 12 is placed against centering guide 36. Flange aperture 41b may be configured to have a diameter, such as a diameter from 30 to 40 mm, that is suitable to receive a receptacle aperture, such as mouth 12, that can be re-sealed or re-plugged by stopper 8.

First cavity 30 is configured to have a dimension that compresses stopper 8 to a compressed stopper diameter size enabling stopper 8 to fit into mouth 12 of receptacle 6 when stopper 8 is pushed along first cavity 30 by protrusion 16, and that permits extraction of compressor 4 away from stopper 8 and receptacle 6 without extracting stopper 8 from mouth 12.

Protrusion 16 is disposed within plunger unit 2 and extends into first cavity 30 when plunger unit 2 is coupled to compressor 4 as shown in FIG. 1. Protrusion length 20 is of a size that, during coupling, will push a stopper, such as stopper 8, along first cavity 30 so as to insert a portion of stopper 8 into mouth 12 when mouth 12 is held against centering guide 36. It is currently contemplated that protrusion length 20 is 15 mm in length but this particular length is not intended to be limiting to the present invention.

First cavity 30 tapers or narrows inwardly from first aperture 32 to second aperture 34. This taper compresses stopper 8 as it is pushed by protrusion 16 along first cavity 30, enabling stopper 8 to be partially inserted within mouth 12. In accordance with one embodiment of the present invention, the tapering or narrowing of first cavity 30 is achieved by implementing a combination of two inwardly tapered cylindrical surfaces, a first cylindrical surface 40 having a taper angle 42 of two (2) degrees from a reference line 43 approximately parallel to centerline 44 and a second cylindrical surface 46 having a taper angle of 48 of six (6) degrees from an reference line 49 approximately parallel to centerline 44. Those of ordinary skill in the art after receiving the benefit of the herein disclosure would readily recognize that implementing a first cavity 30 having a single inwardly tapered surface or more than two taper angles may also be used. Thus, using two inwardly tapered cylindrical surfaces with first cavity 30 or the disclosed taper angles are not intended to limit the present invention in any way. Any number of tapers may be used although first cylindrical surface 40 is dimensioned to hold stopper 8 within a portion of first cavity 30, while second cylindrical surface 46 is dimensioned to compress stopper 8 as it travels linearly along centerline 44 through first cavity 30 and into receptacle 6.

First aperture 32 includes a first aperture diameter 50 of approximately 25 mm but may be any diameter that will permit first cavity 30 to receive stopper 8 and will enable plunger unit 2 to couple with compressor 4. For example, first aperture diameter 50 may range from 21 to 31 mm in the embodiment of the present invention shown in the applicable figures.

Second aperture 34 includes a second aperture diameter 52 that is greater than a mouth diameter, such as mouth diameter 14, of at least one type of receptacle, such as receptacle 6, that is contemplated for use with plunger unit 2 and compressor 4 but less than a stopper diameter of a stopper contemplated to be used to seal receptacle 6. For example, if plunger unit 2 and compressor 4 are intended to be used with a #9 cork stopper that was previously used to seal a wine bottle, second aperture diameter 52 may be configured to have a diameter of approximately 21 mm.

Using a second aperture diameter 52 of 21 mm is not intended to limit the invention in anyway. Any diameter may be used as long as the diameter selected sufficiently compresses stopper 8 so that when pushed along first cavity 30 and against the mouth of a selected receptacle, the diameter of compressed portion of the stopper can be further compressed or deformed through the linear motion 54 of plunger unit 2 during coupling with compressor 4 and thus, facilitating insertion of the deformed portion of stopper 8 into mouth 12 when mouth 12 is held against centering guide 36. In addition, second aperture diameter 52 may also be sized to permit the removal of compressor 4 from receptacle 6 without removing stopper 8 from its inserted position in mouth 12 after stopper 8 is partially inserted into mouth 12.

For example, protrusion length 20, first aperture diameter 50 and second aperture diameter 52 may be configured to have dimensions ranging between and including 10 to 48 mm, 21 to 31 mm and 20 to 22 mm, respectively. When used with a previously a compressed stopper having stopper diameter from 18 to 24 mm, a plunger unit and compressor that are respectively configured to be in these ranges will generally permit the removal of compressor 4 from receptacle 6 without removing a stopper from its inserted position in mouth 12 after a majority of the stopper's length has been inserted into mouth 12.

A typical wine bottle includes a mouth, such as mouth 12, that has an inner cylindrical surface that tapers inwardly from the outer rim of the mouth and towards the enclosed portion of the wine bottle. This taper, such as inner taper 56, further compresses stopper 8 when stopper 8 is pushed against inner taper 56 and partially inserted through mouth 12.

Centering guide 36 is implemented using a centering surface 58, which is oriented at an oblique angle from first surface 38a or in the alternative, from centerline 44. Centering surface 58 is coupled to and is between first surface 38a and an inner annular surface 60 of flange 41a.

Plunger unit 2 and compressor 4 are made of material of sufficient rigidity to permit insertion of the stopper into the mouth of the bottle. For example, plunger unit 2, compressor 4 or both may be of a composition that includes polycarbonate or polymeric material and that are sufficiently translucent to permit a user of plunger unit 2 and compressor 4 to view stopper 8 during insertion into mouth 12.

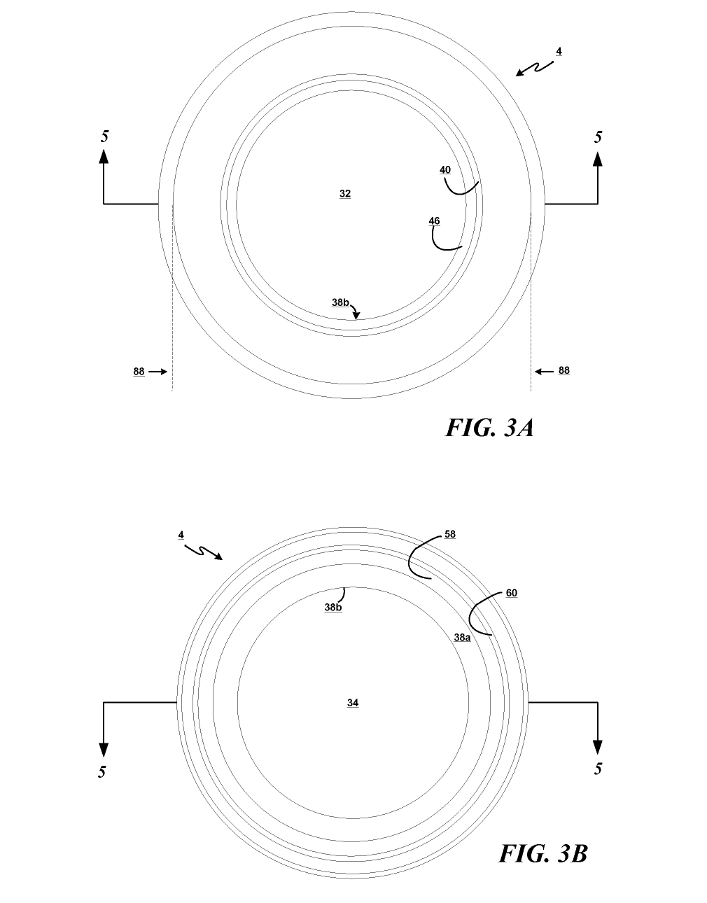

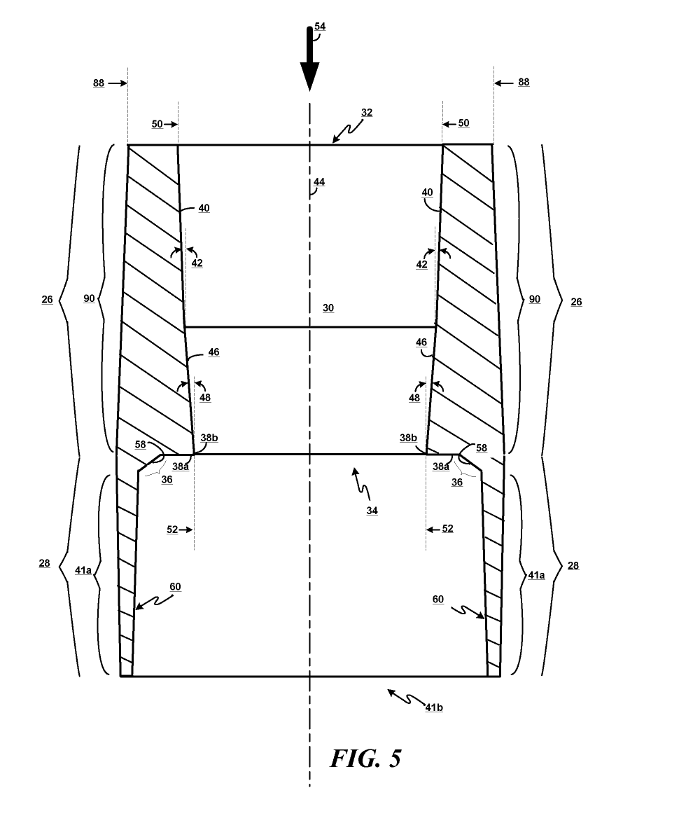

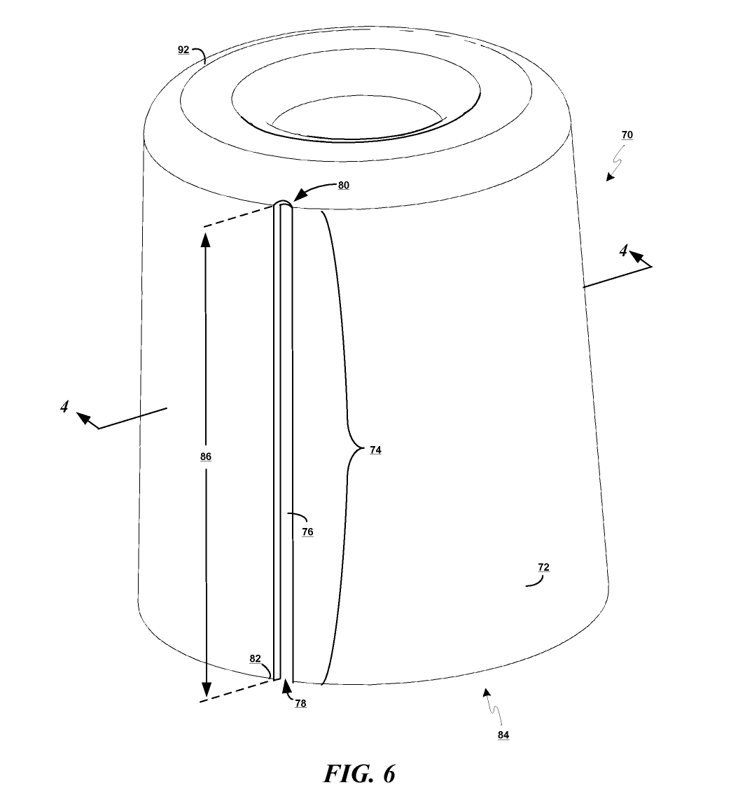

Turning now to FIG. 6, a perspective view of a plunger unit 70 for use with a compressor, such as compressor 4, in accordance with yet another embodiment of the present invention is shown. Plunger unit 70 includes substantially the same elements and function as plunger unit 6 described above, except plunger unit 70 includes a shroud 72 that also includes a slot 74. Slot 74 includes a void 76, which includes an open-end 78 and a closed-end 80. Open-end 78 is located at a shroud edge 82 that defines the boundary of shroud aperture 84, and closed-end 80 is located at selected slot-distance 86 from shroud edge 76. Shroud aperture 84 is intended to be slightly smaller than outside diameter 88 of compressor 4 (see FIGS. 3A and 5) to provide for a friction fit between the inner surface (not shown in FIG. 6) of shroud 72 and a portion of outside surface 90 of compressor 4. Since shroud aperture 84 is slightly smaller than outside diameter 88, slot 74 permits shroud 72 to expand outwardly when plunger 70 is coupled to compressor 4. Providing a friction fit permits plunger unit 70 and compressor 4 to remain coupled through friction, minimizing the possibility of plunger unit 70 and compressor 4 being separately misplaced, while also enabling a user to then de-couple plunger unit 70 and compressor 4 when needed.

In the embodiment shown in FIG. 6, closed-end 80 is located at top surface 92 and slot-distance 86 has a length of approximately 50 mm. It is contemplated that plunger unit 70 and compressor 4 are formed from a plastic or polymer of material, such as polycarbonate. The location of closed-end 80 and the length of slot-distance 86 are not intended to be limiting in any way. Instead, one of ordinary skill in the art would readily recognize after receiving the benefit of the herein disclosure that the location of closed-end 80 and length of slot-distance 86 depend on the properties of the material used to fabricate shroud 72 and compressor 4, the dimensions used for plunger unit 70 and compressor 4 and the amount of friction required or desired to keep plunger unit 70 coupled to compressor 4.

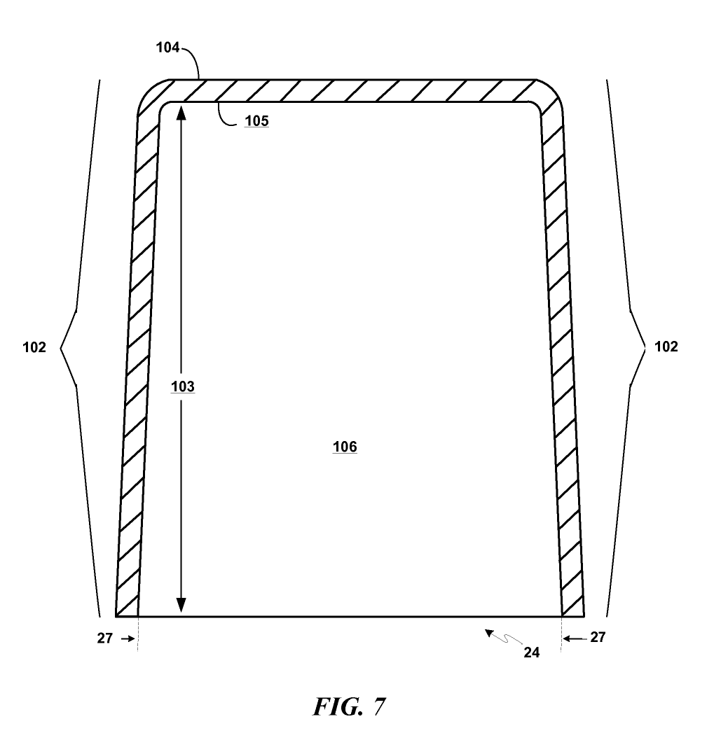

Referring now to FIG. 7, another embodiment of the present invention is shown wherein a plunger unit 100 may be configured without a protrusion. Plunger unit 100 may be configured to have an alignment shroud 102 having a top portion 104, an inner shroud depth 103, a shroud cavity 106 and an open portion that forms a shroud aperture 108. Top portion 104 has an inner surface 105, and shroud aperture 108 has a shroud aperture diameter 110. These elements of plunger unit 100 may be respectively configured to have dimensions substantially equivalent to the dimensions disclosed for the elements of plunger unit 2, disclosed above, except top portion 104 does not include a protrusion 16. Since plunger unit 100 does not have a protrusion and when used in the manner described above with compressor 4, plunger unit 100 functions substantially in the same manner as plunger 2 except plunger unit 100 limits the maximum amount in which stopper 8 may be inserted into receptacle 6.

Further, plunger unit 100 may be used alone without compressor 4 to re-seal receptacle 6 without pushing an end portion 107 of stopper 8 beyond the nearest facing outside edge, such as outside edge 112 in FIG. 1, of mouth 12. For example, after stopper 8 has been partially inserted into receptacle 6, plunger unit 100 may be then used to cover stopper 8 so that inner surface 105 abuts end portion 107, permitting a user to push stopper 8 further into month 12 until top portion 104 rests against outside edge 112. This permits a user to re-seal receptacle without pushing end portion 107 entirely within mouth 12.

While the present invention has been described in particular embodiments, it should be appreciated that the present invention should not be construed as limited by such embodiments. Rather, the present invention should be construed according to the claims below.

We claim:

1. An apparatus for inserting a stopper into a bottle, said bottle having a neck with a mouth having a mouth diameter dimensioned to receive said stopper, the apparatus comprising:
a plunger unit having a protrusion of a selected protrusion length;
a compressor having a first portion and a second portion;
said first portion having a first cavity that has a first aperture and a second aperture;
said second portion having a centering guide for centering the mouth of the bottle when the mouth of the bottle is placed against said centering guide;
wherein said protrusion is of a protrusion length configured to push the stopper into said first cavity so as to partially insert the stopper into the mouth of the bottle when the mouth is held against said centering guide; and
wherein said first cavity has a dimension that compresses the stopper so that the stopper fits into the mouth of the bottle when the stopper is pushed into said first cavity by said protrusion and to permit extraction of said compressor away from the stopper and the bottle without extracting the stopper from the mouth of the bottle.

2. The apparatus of claim 1, wherein said second portion further includes a flange for stabilizing said compressor against the neck of the bottle.

3. The apparatus of claim 1, wherein said dimension of said first cavity includes said second aperture having a second aperture diameter greater than the mouth diameter.

4. The apparatus of claim 3, wherein said second aperture diameter is less than a stopper diameter of the stopper.

5. The apparatus of claim 1, wherein said centering guide includes a first surface and a second surface, said first surface having a first edge defined by said second aperture and said second surface disposed at an oblique angle from said first surface.

6. The apparatus of claim 5, wherein said second portion further includes a flange for stabilizing said compressor against the neck of the bottle, said flange having an inner surface coupled to said second surface.

7. The apparatus of claim 1, wherein said plunger unit and said compressor are made of material of sufficient rigidity to permit insertion of the stopper into the mouth of the bottle.

8. The apparatus of claim 7, wherein said material is sufficiently translucent to permit a user of said plunger unit and said compressor to view the stopper during insertion.

9. The apparatus of claim 7, wherein said material includes any one of polycarbonate and polymeric matter.

10. The apparatus of claim 1, wherein said dimension of said first cavity includes said first aperture having a diameter in the range of approximately 25 mm and said second aperture having a diameter in the range of approximately 20.5 mm.

11. The apparatus of claim 2, wherein said plunger unit includes a shroud cavity having a shroud aperture and said protrusion, said shroud aperture dimensioned to receive said first portion so as to permit said protrusion to drive the stopper partially into the mouth of the bottle when the mouth is held against said centering guide and said plunger unit is pushed onto said compressor, and said protrusion fixed to said plunger unit.

12. An apparatus for inserting a resilient stopper into a bottle, said bottle having a neck, a mouth and a mouth diameter dimensioned to receive said stopper, and said stopper previously inserted into the bottle and having a stopper diameter, the apparatus comprising:
a plunger unit having a protrusion of a selected protrusion length, said protrusion fixed to said plunger unit;
a compressor having a first portion and a second portion, said first portion having a first cavity that has a first aperture and a second aperture;
said second portion having a centering guide for centering the mouth of the bottle when the mouth is placed against the centering guide;
wherein said protrusion is of a protrusion length configured to push the stopper into said first cavity so as to partially insert the stopper into the mouth of the bottle when the mouth is held against said centering guide, said first cavity having at least a first cylindrical surface tapering inwardly;
wherein said first cavity has a dimension that compresses the stopper so that the stopper fits into the mouth of the bottle when the stopper is pushed along said first cavity by said protrusion and to permit extraction of said compressor away from the stopper and the bottle without extracting the stopper from the mouth of the bottle.

13. The apparatus of claim 12, wherein said second portion further includes a flange for stabilizing said compressor against the neck of the bottle.

14. The apparatus of claim 13, wherein said flange is integral with said centering guide and includes an annular inner surface having a first annular end portion adjacent to said centering guide and second annular end portion defining a flange aperture of a flange aperture diameter dimensioned to receive the mouth of the bottle.

15. The apparatus of claim 12, wherein said dimension of said first cavity includes said first aperture having a diameter at least equal to the mouth diameter but is less than most stopper diameters.

16. The apparatus of claim 12, wherein said dimension of said first cavity includes said first aperture having a diameter that is greater than the mouth diameter but is less than most stopper diameters.

17. The apparatus of claim 12, wherein said centering guide includes a first surface and a second surface, said first surface having a first edge defined by said second aperture and said second surface disposed at an oblique angle from said first surface.

18. The apparatus of claim 17, wherein said second portion further includes a flange for stabilizing said compressor against the neck of the bottle, said flange having an inner surface coupled to said second surface.

19. The apparatus of claim 12, wherein said material is sufficiently translucent to permit a user of said plunger unit and said compressor to view a position of the stopper through said compressor during use.

20. The apparatus of claim 12, wherein said dimension of said first cavity includes said first aperture having a diameter in the range of approximately 25 mm and said second aperture having a diameter in the range of approximately 20.5 mm.

21. The apparatus of claim 12, wherein said plunger unit includes a shroud cavity having a shroud aperture and said protrusion, said shroud aperture dimensioned to receive said first portion so as to permit said protrusion to drive the stopper partially into the mouth of the bottle when the mouth is held against said centering guide and said plunger unit is pushed onto said compressor.

22. The apparatus of claim 21, wherein said plunger unit further includes a shroud having a slot.

23. The apparatus of claim 12, wherein said first cavity further includes an inwardly tapered cylindrical second surface, said second surface for compressing the stopper when the stopper is pushed along said first cavity by said protrusion.

24. An apparatus for inserting a stopper into a bottle, said bottle having a neck with a mouth having a mouth diameter dimensioned to receive said stopper, the apparatus comprising:
a plunger unit means having a protrusion of a selected protrusion length;
a compressor means having a first portion and a second portion, said first portion having a first cavity that has a first aperture and a second aperture;
said second portion having a centering means, said centering means for centering the mouth of the bottle when the mouth of the bottle is inserted against the centering means;
wherein said protrusion has a protrusion length sufficient to push the stopper into said first cavity so as to partially insert the stopper into the mouth of the bottle when the mouth is held against said centering means, said first cavity tapering inwardly from said first aperture to said second aperture;
wherein said first cavity has a dimension that sufficiently compresses the stopper so that the stopper fits into the mouth of the bottle when the stopper is pushed into said first cavity by said protrusion and to permit extraction of said compressor means away from the stopper and the bottle without extracting the stopper from the mouth of the bottle.

25. The apparatus of claim 24, wherein said first cavity further includes a first inwardly tapered cylindrical surface and a second inwardly tapered cylindrical surface, said second inwardly tapered cylindrical surface for compressing the stopper when the stopper is pushed along said first cavity by said protrusion.

26. The apparatus of claim 24, wherein said plunger unit further includes an alignment shroud and said protrusion is fixed to said alignment shroud.

27. The apparatus of claim 26, wherein said alignment shroud includes a slot.

28. An apparatus for compressing a stopper so that at least a portion of the stopper fits into a mouth of receptacle, the apparatus comprising:
a first portion and a second portion, said first portion having a first cavity that has a first aperture and a second aperture;
said second portion having a centering guide for centering the mouth of the receptacle when the mouth of the receptacle is placed against said centering guide;
wherein said first cavity has a dimension that compresses the stopper so that the stopper fits into the mouth of the receptacle when the stopper is pushed into said first cavity and to permit extraction of said compressor away from the stopper and the receptacle without extracting the stopper from the mouth of the receptacle.

29. The apparatus of claim 28, wherein said second portion further includes a flange for stabilizing said compressor against a neck of the receptacle.

30. The apparatus of claim 28, wherein said dimension of said first cavity includes said second aperture having a second aperture diameter greater than the mouth diameter.

31. The apparatus of claim 28, wherein said second aperture diameter is less than a stopper diameter of the stopper.

32. The apparatus of claim 28, wherein said centering guide includes a first surface and a second surface, said first surface having a first edge defined by said second aperture and said second surface disposed at an oblique angle from said first surface.

33. The apparatus of claim 32, wherein said second portion further includes a flange for stabilizing said compressor against said neck, said flange having an inner surface coupled to said second surface.

34. The apparatus of claim 28, further including a plunger unit having a protrusion of a selected protrusion length configured to push the stopper into said first cavity so as to partially insert the stopper into the mouth of the receptacle when the mouth is held against said centering guide.

35. The apparatus of claim 34, wherein said plunger unit includes a shroud cavity having a shroud aperture and said protrusion, said shroud aperture dimensioned to receive said first portion so as to permit said protrusion to drive the stopper partially into the mouth of the receptacle when the mouth is held against said centering guide and said plunger unit is coupled to said compressor, and said protrusion fixed to said plunger unit.

36. The apparatus of claim 28, wherein said first and second portions are made of material of sufficient rigidity to permit insertion of the stopper into the mouth of the receptacle.

37. The apparatus of claim 36, wherein said material is sufficiently translucent to permit a user to view a portion of the stopper located within said first cavity when said stopper is pushed into said first cavity.

38. The apparatus of claim 37, wherein said material includes a polymer.

39. The apparatus of claim 28, wherein said dimension of said first cavity includes said first aperture having a diameter in the range of approximately 25 mm and said second aperture having a diameter in the range of approximately 20.5 mm.

40. An apparatus for inserting a stopper into a bottle, said bottle having a neck with a mouth having a mouth diameter dimensioned to receive said stopper, the apparatus comprising:
a plunger unit;
a compressor having a first portion and a second portion;
said first portion having a first cavity that has a first aperture and a second aperture;
said second portion having a centering guide for centering the mouth of the bottle when the mouth of the bottle is placed against said centering guide; and
wherein said first cavity has a dimension that compresses the stopper so that the stopper fits into the mouth of the bottle when the stopper is pushed into said first cavity by said plunger unit and to permit extraction of said compressor away from the stopper and the bottle without extracting the stopper from the mouth of the bottle.

41. The apparatus of claim 40, wherein:
said plunger unit includes a protrusion of a selected protrusion length;
said protrusion length configured to push the stopper into said first cavity so as to partially insert the stopper into the mouth of the bottle when the mouth is held against said centering guide.

42. The apparatus of claim 40, wherein said second portion further includes a flange for stabilizing said compressor against the neck of the bottle.

43. The apparatus of claim 40, wherein said dimension of said first cavity includes said second aperture having a second aperture diameter greater than the mouth diameter.

44. The apparatus of claim 43, wherein said second aperture diameter is less than a stopper diameter of the stopper.

45. The apparatus of claim 40, wherein said centering guide includes a first surface and a second surface, said first surface having a first edge defined by said second aperture and said second surface disposed at an oblique angle from said first surface.

46. The apparatus of claim 45, wherein said second portion further includes a flange for stabilizing said compressor against the neck of the bottle, said flange having an inner surface coupled to said second surface.

47. The apparatus of claim 40, wherein said plunger unit and said compressor are made of material of sufficient rigidity to permit insertion of the stopper into the mouth of the bottle.

48. The apparatus of claim 47, wherein said material is sufficiently translucent to permit a user of said plunger unit and said compressor to view the stopper during insertion.

49. The apparatus of claim 47, wherein said material includes any one of polycarbonate and polymeric matter.

50. The apparatus of claim 40, wherein said dimension of said first cavity includes said first aperture having a diameter in the range of approximately 25 mm and said second aperture having a diameter in the range of approximately 20.5 mm.

51. The apparatus of claim 41, wherein said plunger unit includes a shroud cavity having a shroud aperture and said protrusion, said shroud aperture dimensioned to receive said first portion so as to permit said protrusion to drive the stopper partially into the mouth of the bottle when the mouth is held against said centering guide and said plunger unit is pushed onto said compressor, and said protrusion fixed to said plunger unit.

52. The apparatus of claim 40, wherein said plunger unit includes a shroud cavity having a shroud aperture and said protrusion, said shroud aperture dimensioned to receive said first portion so as to permit said protrusion to drive the stopper partially into the mouth of the bottle when the mouth is held against said centering guide and said plunger unit is pushed onto said compressor, and said protrusion fixed to said plunger unit.

53. The apparatus of claim 40, wherein said plunger unit includes a protrusion of a protrusion length equal to zero millimeters.
